(19) United States
(12) Patent Application Publication
(10) Pub. No.: US 2005/0215248 A1
(43) Pub. Date: Sep. 29, 2005

(54) Method and system of communication between a master device and a slave device

(75) Inventor: Gregory Lee Brookshire, Cary, NC (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/806,881

(22) Filed: Mar. 23, 2004

(51) Int. Cl. H04Q 7/20

(52) U.S. Cl. 455/426.1

(57) ABSTRACT

A system for reducing power consumption in a portable electronic device comprises a master device coupled to a slave device via a serial interface. The slave device is configurable by the master device to operate in multiple modes wherein each mode is associated with a command length that differs between modes.

### FIELD OF THE INVENTION

The subject matter disclosed herein relates generally to communication between electronic devices, and more particularly to communication via battery-operated devices.

### BACKGROUND

Portable electronic devices such as cell phones, personal digital assistants (PDAs), and laptop computers are dependent on battery power when not plugged into a power outlet or a host device. Accordingly, there is an ongoing effort to increase the efficiency of batteries and/or decrease the power requirements of portable electronic devices such that the amount of time a portable electronic device can operate solely on battery power increases.

### SUMMARY

A system for reducing power consumption in an electronic device comprises a master device coupled to a slave device via a serial interface. The slave device is configurable by the master device to operate in multiple modes wherein each mode is associated with a command length that differs between modes.

### BRIEF DESCRIPTION OF THE DRAWINGS

For a detailed description of various embodiments of the invention, reference will now be made to the accompanying drawings in which:

FIG. 1 illustrates a system in accordance with preferred embodiments of the invention;

FIG. 2 illustrates an alternative system in accordance with other preferred embodiments of the invention;

FIG. 3 illustrates a preferred embodiment of an initialization command usable in the systems of FIGS. 1 and 2;

FIG. 4a illustrates a preferred embodiment of a read/write command usable in the systems of FIGS. 1 and 2;

FIG. 4b illustrates a preferred embodiment of an alternative read/write command usable in the systems of FIGS. 1 and 2;

FIG. 5a illustrates a write process using 16-bit data transfers in accordance with a preferred embodiment of the invention;

FIG. 5b illustrates a read process using 16-bit data transfers in accordance with a preferred embodiment of the invention;

FIG. 5c illustrates a write process using 32-bit data transfers in accordance with a preferred embodiment of the invention;

FIG. 5d illustrates a read process with 32-bit data transfers in accordance with a preferred embodiment of the invention;

FIG. 6 illustrates a clocking diagram in accordance with a preferred embodiment of the invention; and

FIG. 7 illustrates a method in accordance with a preferred embodiment of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

As will be described herein, various preferred embodiments of the invention are directed to providing methods and systems for reducing power consumption in electronic devices. In particular, portable electronic devices such as cell phones, PDAs, and laptop computers may benefit from reduced power consumption. The disclosed embodiments are directed to reducing power consumption by reducing the number of clock cycles expended by a master device (e.g., a processor) to communicate with a slave device. In at least some embodiments, the slave device may be a wireless local area network (“WLAN”) adapter. Alternatively, the slave device may be any device configurable for use with a serial interface such as the serial peripheral interface (SPI). In general, however, no restriction is placed on the nature of the devices. That is, the devices may or may not be portable, may or may not be battery-operated, and may be used for any purpose (not just WLAN adapters, cell phones, PDAs, etc.).

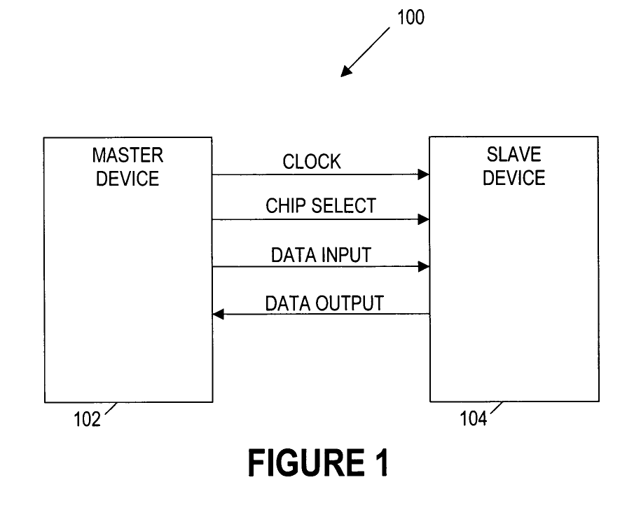

FIG. 1 illustrates a system 100 in accordance with preferred embodiments of the invention. As shown in FIG. 1, the system 100 may comprise a master device 102 coupled to a slave device 104 via a serial peripheral interface (SPI). SPI comprises a physical interface having a clock signal line, a chip select line, a data input (DI) line, and a data output (DO) line. However, SPI does not define a communication protocol (i.e., SPI does not give meaning to bits of data transmitted via the DI and DO lines.

In accordance with SPI, the clock signal may be controlled by the master device 102. In some embodiments, the clock signal may idle (i.e., stay at a logical “0” value) unless the master device 102 is sending data to and/or expecting to receive data from the slave device 104. When the master device 102 toggles the clock signal, one bit of data is exchanged between the master device 102 and the slave device 104 via the DI and DO lines. More specifically, the master device 102 sends one bit to the slave device 104 via the DI line, while the slave device 104 sends one bit to the master device 102 via the DO line. As previously mentioned, the significance of the data may be defined by a communication protocol as will later be described. To notify the slave device 104 of an impending exchange of data, the master device 102 may toggle a signal on the chip select line. For example, the chip select signal may be asserted and de-asserted before every word (group of bits) is transferred from the master device 102 to the slave device 104. During the transfer of each word, the chip select signal may stay de-asserted (i.e., in a low state).

In at least some embodiments, the master device 102 may execute software instructions that control the timing and content of communication between the master device 102 and the slave device 104 via the SPI interface. In particular, the software instructions may direct the master device 102 to assert the clock signal and the chip select line as described above. Additionally, the software instructions may define the length and content of commands that give meaning to the data exchanged between the master device 102 and the slave device 104. In at least some embodiments, the master device 102 may implement an initialization command that configures the slave device 104 in one of multiple modes. Preferably, each mode is associated with a different read/write command length (e.g., 48-bits, 32-bits, 16-bits, 8-bits), wherein each read/write command comprises at least one bit that indicates whether the command is a read command or a write command, bits that define an amount of data associated with the read/write command, and bits that indicate an address associated with the read/write command.

Operating in each mode may be beneficial or detrimental to the speed and/or power requirements of communication between the master device 102 and the slave device 104. For example, a first mode that implements 32-bit read/write commands may allow faster clocking than a second mode that implements 16-bit read/write commands. However, operating in the first mode may consume more power than operating in the second mode. The benefits of operating in the first mode or second mode may be based, for example, on how memory/register addresses of the slave device 104 are accessed.

In some embodiments, the slave device 104 may implement direct addressing when configured in the first mode and indirect addressing when configured in the second mode. With direct addressing, an address in a read/write command corresponds directly with memory/register addresses of the slave device 104. With indirect addressing, an address in a read/write command does not correspond directly with memory/register addresses of the slave device 104. Therefore, the slave device 104, when configured in a second mode, may implement logic that formats an indirect address to a memory/register address.

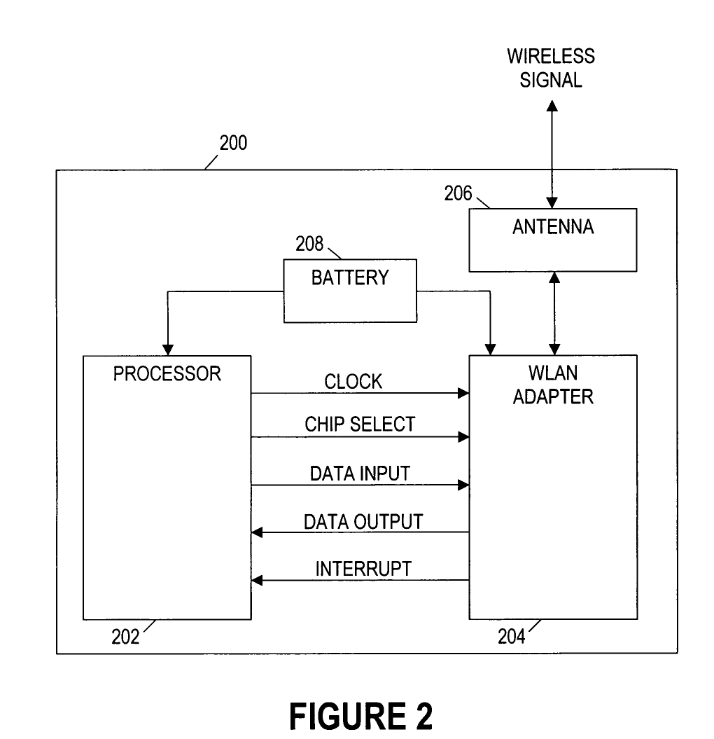

FIG. 2 illustrates an alternative system 200 in accordance with preferred embodiments of the invention. As shown in FIG. 2, the system 200 comprises a processor 202 (e.g., a host processor of a computer system) coupled to a WLAN adapter 204. The processor 202 and the WLAN adapter 204 may couple to and receive power from a battery 208. In at least some embodiments, the system 200 may be representative of portable electronic devices such as cell phones, PDAs, and laptop computers that provide wireless communication capabilities. As shown, the WLAN adapter 204 may couple to an antenna 206 that sends and receives wireless signals.

To provide wireless communication capabilities to the system 200, the processor 202 may communicate with the WLAN adapter 204 using a serial interface such as SPI. As described above, SPI may include a clock signal (“CLK”), a chip select signal (“CS”), a data input signal (“DI”), and a data output signal (“D0”). Additionally, the system 200 may comprise an interrupt signal that allows the WLAN adapter 204 to interrupt the processor 202. For example, the WLAN adapter 204 may receive data from the antenna 206 and store the data in a memory (not shown) of the WLAN adapter. Subsequently, the WLAN adapter 204 may assert a signal on the interrupt line to request the processor 202 to process received data. Additionally or alternatively, the WLAN adapter 204 may assert a signal on the interrupt line to notify the processor 202 that the WLAN adapter 204 is ready to transmit data.

In at least some embodiments, the processor 202 may communicate with the WLAN adapter 204 to establish wireless communications links according to wireless protocols such as the IEEE 802.11 family of wireless protocols. In such embodiments, the WLAN adapter 204 may perform several functions (e.g., scanning frequency channels, preparing data frames according to the wireless protocol, and modulating/demodulating data) related to sending and receiving wireless data. In order to perform such functions, the WLAN adapter 204 receives values and instructions from the processor 202. Accordingly, the processor 202 may configure the WLAN adapter 204 to operate in one of multiple modes as described above. Thereafter, the processor 202 may transmit read/write commands that comport with the command length programmed into the WLAN adapter 204.

When the system 200 is operating on battery power, the processor 202 preferably configures the WLAN adapter 204 to operate in a low power mode. In at least some embodiments, the low power mode is associated with low power compatible commands (i.e., commands that cause the processor 202 and/or WLAN adapter 204 to consume less power than other commands). As explained above, a read/write command (including an address associated with the read or write) having fewer bits than another read/write command permits the processor 202 to communicate to the WLAN adapter 204 with fewer clock cycles, thus saving power.

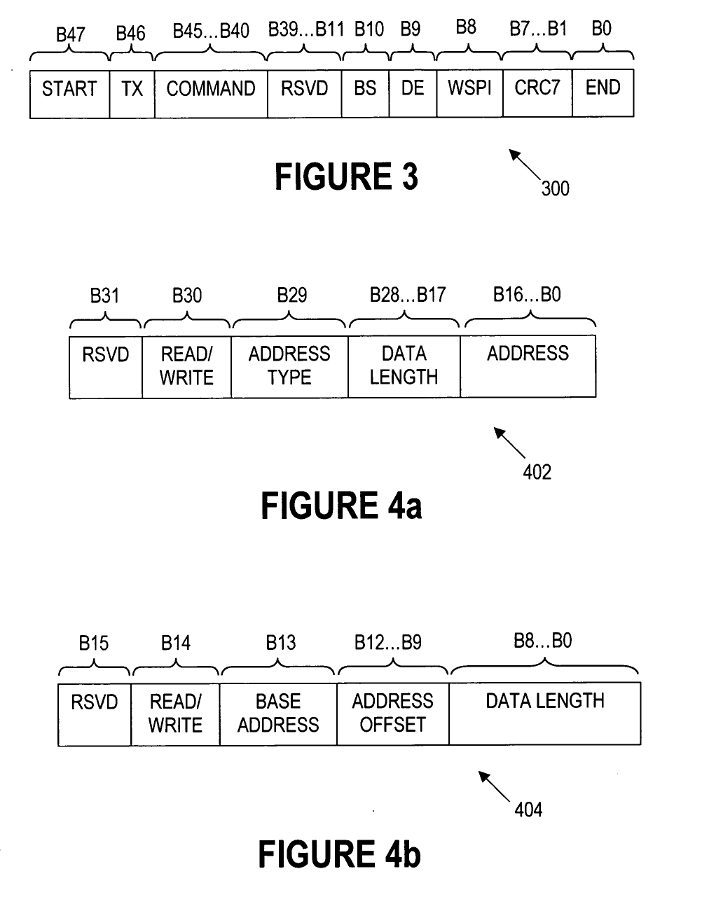

FIG. 3 illustrates a preferred embodiment of an initialization (configuration) command 300 usable in the systems of FIGS. 1 and 2. In at least some embodiments, the initialization command 300 may comprise a Secure Digital Input/Output (SDIO) protocol command. As shown in FIG. 3, the initialization command 300 may comprise 48-bits (B47-B0) divided into “START,” “TX,” “COMMAND,” “RSVD,” “BS,” “DE,” “WSPI,” “CRC7” and “END” fields. The START field may comprise one bit (B47) that indicates the beginning of the initialization command 300. The START bit may have a logical “0” value. The TX field may comprise one bit (B46) that indicates a transmission of data. The TX bit may have a logical “1” value. In some embodiments, the TX bit may correspond to a TX bit defined by the SDIO protocol. The START bit and/or the TX bit may enable the WLAN adapter 204 to detect a new command 300.

The COMMAND field may comprise six bits (B45-B40) that indicate a predetermined command to the WLAN adapter 204. For example, the COMMAND field bits may designate that the command 300 is associated with a read command, write command, or initialization command. In at least some embodiments, the COMMAND bits may comprise all logical “0” values to encode the command 300 as an initialization command according to the SDIO protocol. The RSVD (reserved) field may comprise twenty-nine bits (B39-B11) reserved for future use. The RSVD bits may have logical “0” values. The BS (bit swizzle) field may comprise one bit (B10) that indicates whether data is transmitted with a most significant bit first or a least significant bit first. If the BS bit is a logical “0,” the data is transmitted with a most significant bit first. If the BS bit is a logical “1,” the data is transmitted with a least significant bit first. The DE (data endianess) field may comprise one bit (B9) that indicates whether data is transmitted according to a Little Endian protocol or a Big Endian protocol. A Little Endian protocol means that the lowest-order byte of multiple-byte word is stored in memory at the lowest address, and the highest-order byte at the highest address (i.e., the “little” end of the word is transmitted first). Alternatively, a Big Endian protocol means that the highest-order byte of a multiple-byte word is stored in memory at the lowest address, and the lowest-order byte at the highest address (i.e., the “big” end is transmitted first). If the DE bit is a logical “0,” data is transmitted according to a Little Endian protocol. If the DE bit is a logical “1,” data is transmitted according to a Big Endian protocol.

The WSPI (wireless serial peripheral interface) field may comprise one bit (B8) that indicates the length of read/write commands that the processor 202 sends to the WLAN adapter 204. For example, if the WSPI bit is a logical “1,” the processor 202 may send 16-bit read/write commands to the WLAN adapter 204. If the WSPI bit is a logical “0,” the processor 202 may send 32-bit read/write commands to the WLAN adapter 204. In some embodiments, the WSPI field may comprise more than one bit. Therefore, embodiments of the invention are not limited to just two modes as described previously. The CRC7 (cyclic redundancy check) field may comprise seven bits (B7-B1) representative of a cyclic redundancy check (CRC). The CRC7 bits may be examined to detect errors during data transmission. The END field may comprise one bit (B0) that indicates the end of the initialization command 300. The END bit may have a logical “1” value.

In at least some embodiments, the processor 202 may send the initialization command 300 to the WLAN adapter 204 in three 16-bit segments (i.e., words). The three 16-bit segments may be stored in registers (not shown) of the WLAN adapter 204 and interpreted as described above.

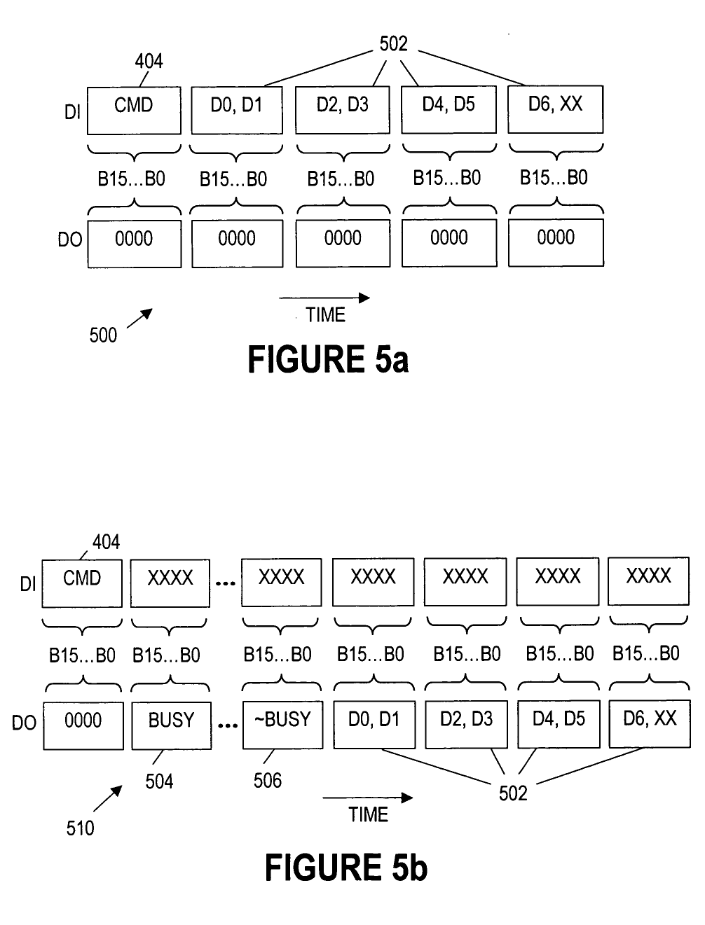

FIG. 4a illustrates a preferred embodiment of a read/write command 402 usable with the systems of FIGS. 1 and 2. As shown in FIG. 4a, the read/write command 402 may comprise thirty-two bits (B31-B0) divided into “RSVD,” “READ/WRITE,” “ADDRESS TYPE,” “DATA LENGTH” and “ADDRESS” field. The RSVD (reserved) field may comprise one bit (B31) that is reserved for future use. The RSVD bit may have a logical “1” value. The READ/WRITE field may comprise one bit (B30) that indicates whether the command 402 is a read command or a write command. For example, if the READ/WRITE bit is a logical “0,” the command 402 may be a write command. If the READ/WRITE bit is a logical “1,” the command 402 may a read command.

The ADDRESS TYPE field may comprise one bit (B29) that indicates whether the address is a fixed address or an incrementing address. For example, if the ADDRESS TYPE bit is a logical “0,” the address may be an incrementing address. If the ADDRESS TYPE bit is a logical “1,” the address may be a fixed address. The DATA LENGTH field may comprise twelve bits (B28-B17) that indicate an amount of data (i.e., a number of byes) that will be written or read. Therefore, the twelve bits may indicate a data length up to 4096 (i.e., 2¹²) bytes. The ADDRESS field may comprise seventeen bits (B16-B0) that indicate an address associated with the command 402.

FIG. 4b illustrates an alternative preferred embodiment of a read/write command 404 usable with the systems of FIGS. 1 and 2. As shown in FIG. 4b, the command 404 may comprise sixteen bits (B15-B0) divided into “RSVD,” “READ/WRITE,” “BASE ADDRESS,” “ADDRESS OFFSET” and “DATA LENGTH” fields. The RSVD field may comprise one bit (B15) that is reserved for future use. The RSVD bit may have a logical “0” value. The READ/WRITE field may comprise one bit (B14) that indicates whether the command 404 is a read command or a write command. For example, if the READ/WRITE bit is a logical “0,” the command 404 may be a write command. If the READ/WRITE bit is a logical “1,” the command 404 may be a read command.

The BASE ADDRESS field may comprise one bit (B13) that indicates whether a base address (e.g., a double word address) is a first predetermined address or a second predetermined address. For example, if the BASE ADDRESS bit is a logical “0,” the base address may be “0.” If the BASE ADDRESS bit is a logical “1,” the base address may be “48d” corresponding to a decimal address 48. The ADDRESS OFFSET field may comprise four bits (B12-B9) that indicate an offset from the base address described above. For example, if a desired address is 58d and the base address is 48d, then the ADDRESS OFFSET bits may indicate an offset equal to 58d-48d=10d. In some embodiments an offset of 10d may be indicated using a four-bit binary number (i.e., 10d=1010). The DATA LENGTH field may comprise nine bits (B8-B0) that indicate a number of 32-bits words to move. Therefore, the DATA LENGTH bits may indicate up to 512 (i.e., 2⁹) 32-bit words (i.e., 2048 bytes) will be moved to/from an address.

In at least some embodiments, the 16-bit read/write command 404 corresponds with an indirect memory access scheme. For example, the 16-bit command 404 described above comprises a BASE ADDRESS bit to select a base address and ADDRESS OFFSET bit to select an offset from the base address.

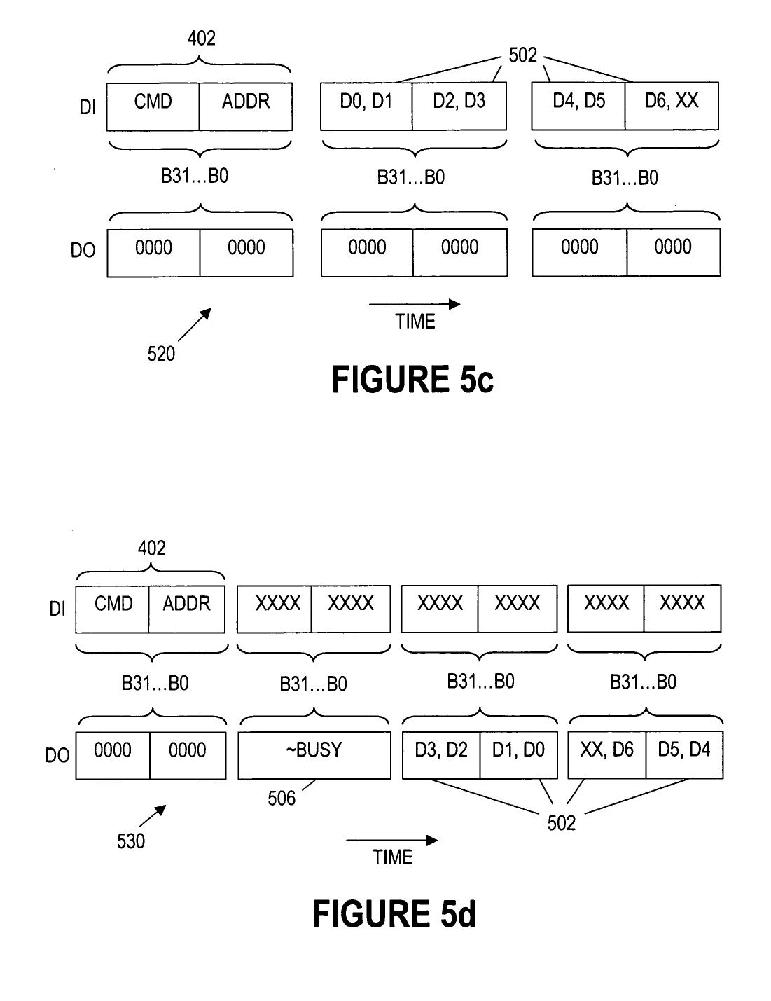

FIG. 5a illustrates a write process 500 using 16-bit (B15-B0) data transfers in accordance with preferred embodiments of the invention. As shown in FIG. 5a, the write process 500 may comprise sending the command 404 and data 502 via the DI line. Specifically, FIG. 5a illustrates the transfer of seven bytes of data (D0-D6) from the master device 102 to the slave device 104 according to a Big Endian protocol (i.e., the data bytes are transferred in the order D0-D6). As shown, the slave device 104 may transfer zeros (or other insignificant data) to the master device 102 during the write process 500 via the DO line.

FIG. 5b illustrates a read process 510 using 16-bit (B15-B0) data transfers in accordance with preferred embodiments of the invention. As shown in FIG. 5b, the read process 510 may comprise sending the command 404 via the DI line. After the command 404, the slave device 104 may transmit a busy signal (“BUSY”) 504 to the master device 102 via the DO line. When the slave device 104 is available, a not busy signal (˜BUSY) 506 may be sent to alert the master device 102 that the slave device 104 will subsequently transmit the requested data 502 via the DO line. Specifically, FIG. 5b illustrates the transfer of seven bytes of data (D0-D6) from the slave device 104 to the master device 102 according to a Big Endian protocol. As shown in FIG. 5b, the master device 102 may transmit insignificant data (“X”) to the slave device 104 while the slave device transmits the busy signal 504, not busy signal 506, and the data 502.

FIG. 5c illustrates a write process 520 using 32-bit (B31-B0) data transfers in accordance with preferred embodiments of the invention. As shown in FIG. 5c, the write process 520 may comprise the master device 102 sending the command 402 and the data 502 to the slave device 104 via the DI line. Specifically, FIG. 5c illustrates the transfer of seven bytes of data (D0-D6) from the master device 102 to the slave device 104 according to a Big Endian protocol. As shown, the slave device 104 may transfer zeros (or other insignificant data) to the master device 102 during the write process 520 via the DO line.

FIG. 5d illustrates a read process 530 using 32-bit (B31-B0) data transfers in accordance with embodiments of the invention. As shown in FIG. 5d, the read process 530 may comprise the master device 102 sending the command 402 to the slave device 104 via the DI line. After the command 402, the slave device 104 may send a not busy signal (˜BUSY) 504, which alerts the master device 102 that the slave device 104 will subsequently transmit data 502 via the DO line. Specifically, FIG. 5d illustrates the transfer of seven bytes of data (D0-D6) from the slave device 104 to the master device 102 according to a Little Endian protocol (i.e., the order of bytes for each 32-bit data transfer is reversed). More specifically, after the ˜BUSY signal 504, the data bytes are transferred in two 32-bit (4-byte) words (D3, D2, D1, D0) and (XX, D6, D5, D4) where (“XX”) is a byte of insignificant data. As shown in FIG. 5d, the master device 102 may transmit insignificant data (“X”) on the DI line while the slave device 104 transmits the not busy signal 506 and the data 502.

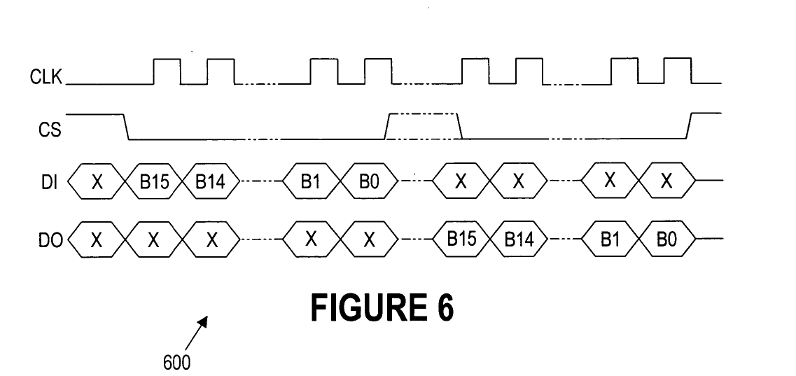

FIG. 6 illustrates a clocking diagram 600 in accordance with embodiments of the invention. As shown in FIG. 6, data (B15-B0) may be transmitted over the DI line with each clock cycle. As described above, the data transferred over the DI line may comprise commands 402 and 404, addresses, and write data, while the data transferred over the DO line may comprise busy signals, not busy signals, and read data. In some embodiments, the clock may toggle when data is on the DI line or expected on the DO line and idle (i.e., remain at a logical “0” value) otherwise. Additionally, in some embodiments, the CS line may toggle between word transfers.

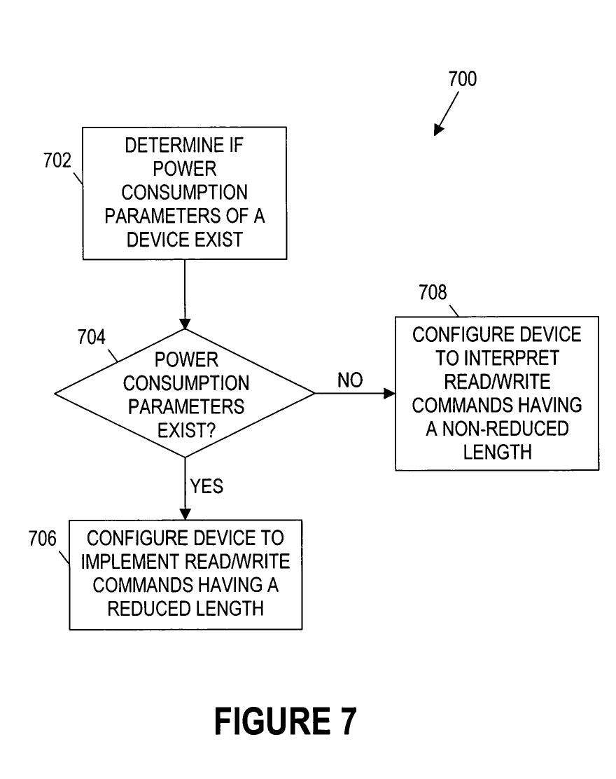

FIG. 7 illustrates a method 700 in accordance with embodiments of the invention. As shown in FIG. 7, the method 700 may comprise determining power consumption parameters of a device (block 702). For example, the power consumption parameters may comprise whether a battery is powering the device and/or whether a battery has greater than or equal to a predetermined threshold of available power. If the power consumption parameters are met (i.e., if the device is powered by battery and/or if the battery has less than a predetermined amount of available power), as determined at block 704, the device is configured to implement read/write commands having a reduced length (block 706). For example, a device that implements 32-bit read/write commands may implement 16-bit read/write commands when the power consumption parameters are met. Otherwise, the device is configured to implement read/write commands having a non-reduced length (block 708).

While the preferred embodiments of the present invention have been shown and described, modifications thereof can be made by one skilled in the art without departing from the spirit and teachings of the invention. For example, other embodiments may implement configuration (i.e., initialization) commands, read commands and/or write commands that use a different number of bits than the embodiments shown in FIG. 3 and FIGS. 4a-4b. The embodiments described herein are exemplary only, and are not intended to be limiting. Many variations and modifications of the invention disclosed herein are possible and are within the scope of the invention. Accordingly, the scope of protection is not limited by the description set out above. Each and every claim is incorporated into the specification as an embodiment of the present invention.

1. A system, comprising:
a master device; and
a slave device coupled to the master device via a serial interface, the slave device is configurable by the master device to operate in multiple modes wherein each mode is associated with a command length that differs between modes.

2. The system of claim 1 wherein the master device configures the slave device to operate in the multiple modes using an initialization command having a length that is greater than the command lengths associated with the multiple modes.

3. The system of claim 1 wherein the master device comprises a processor of a battery operated electronic device.

4. The system of claim 1 wherein the slave device comprises a wireless LAN adapter, the wireless LAN adapter couples to an antenna that transmits and receives wireless signals according to a wireless protocol.

5. The system of claim 1 wherein commands associated with the command length comprises read/write commands.

6. The system of claim 1 wherein the master and slave devices implement indirect memory accesses during at least one of the multiple modes.

7. The system of claim 1 wherein the serial interface comprises a serial peripheral interface (SPI).

8. A portable device, comprising:
a processor;
a slave device couple to the processor; and
a battery coupled to the processor and the slave device, the battery is operable to provide power to the processor and the slave device,
wherein the processor and the slave device are configurable to communicate in multiple modes, each mode being associated with a different read/write command length.

9. The portable device of claim 8 wherein each read/write command comprises a read/write field, a data length field, and an address field.

10. The portable device of claim 8 wherein one of the multiple modes comprises to a low power compatible mode that implements a command length having fewer bits than another of the multiple modes.

11. The portable device of claim 10 wherein the processor and the slave device are configured to communicate in the low power compatible mode when only the battery provides power to the processor and the slave device.

12. The portable device of claim 10 wherein the processor and the slave device are configured to communicate in the low power compatible mode when the battery has less than a predetermined threshold amount of power available to power the processor and the slave device.

13. A method, comprising:
determining if a power consumption parameter of a device exists;
configuring a device to interpret read/write commands having a non-reduced length; and
configuring the device to interpret read/write commands having a reduced length if the power consumption parameter exists.

14. The method of claim 13 wherein the non-reduced length comprises 32-bits.

15. The method of claim 14 wherein the reduced length comprises 16-bits.

16. The method of claim 13 further comprising performing functions associated with a wireless communication protocol in response to an interpretation of the read/write commands.

17. The method of claim 13 wherein the power consumption parameter comprises the device being powered by a battery

18. The method of claim 13 wherein the power consumption parameter comprises a battery powering the device having less than a predetermined threshold amount of available power.

19. A system, comprising:
a first device;
a second device coupled to the first device;
means for configuring the second device in a first mode associated with commands having a non-reduced length; and
means for configuring the second device in a second mode associated with commands having a reduced length.

20. The system of claim 19 further comprising means for determining when to configure the second device in the first and second modes.

21. The system of claim 19 wherein the means for configuring the second device in the first and second modes comprises a Secure Digital Input/Output (SDIO) command transmitted from the first device to the second device.
